(19) United States
(12) Patent Application Publication
(10) Pub. No.: US 2006/0016066 A1
(43) Pub. Date: Jan. 26, 2006

(54) Pick and place machine with improved inspection

(75) Inventors: John D. Gaida, Victoria, MN (US); Paul R. Haugen, Bloomington, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: CyberOptics Corporation, Golden Valley, MN (US)

(21) Appl. No.: 11/185,920

(22) Filed: Jul. 20, 2005

Related U.S. Application Data
(63) Continuation-in-part of application No. 10/979,750, filed on Nov. 2, 2004.
(63) Continuation-in-part of application No. 10/970,355, filed on Oct. 21, 2004.
(60) Provisional application No. 60/589,767, filed on Jul. 21, 2004.

(51) Int. Cl. B23Q 17/00

(52) U.S. Cl. 29/740; 29/407.04; 29/720; 29/834

(57) ABSTRACT

Embodiments of the present invention provide correlation between positional information relative to the workpiece and inspection information acquired relative to the workpiece. This correlation helps a user or technician quickly identify the physical location, on the workpiece, to which the inspection information pertains. Component inspection information can then be provided to an operator along with an indication of a position of the inspected component on the workpiece.

### CROSS-REFERENCE TO RELATED APPLICATIONS

The present application is based on and claims the benefit of U.S. provisional patent application Ser. No. 60/589,767, filed Jul. 21, 2004, the content of which is hereby incorporated by reference in its entirety; and the present application is a Continuation-In-Part application of U.S. patent application Ser. No. 10/979,750, filed Nov. 2, 2004, which application claims the benefit of U.S. Provisional Application Ser. No. 60/518,260, filed Nov. 7, 2003; and the present application is a Continuation-In-Part application of U.S. patent application Ser. No. 10/970,355, filed Oct. 21, 2004, which application claims the benefit of U.S. Provisional Application Ser. No. 60/517,184, filed Nov. 4, 2003.

### COPYRIGHT RESERVATION

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Electronic assembly machines, also known as pick and place machines, are generally used to manufacture electronic circuit boards. A blank printed circuit board is usually supplied to the pick and place machine, which then picks electronic components from component feeders, and places such components upon the board. The components are held upon the board temporarily by solder paste, or adhesive, until a subsequent step in which the solder paste is melted or the adhesive is fully cured.

Pick and place machine operation is challenging. Since machine speed corresponds with throughput, the faster the pick and place machine runs, the less costly the manufactured board will be. Additionally, placement accuracy is extremely important. Many electrical components, such as chip capacitors and chip resistors are relatively small and must be accurately placed on equally small placement locations. Other components, while larger, have a significant number of leads or conductors that are spaced from one another at a relatively fine pitch. Such components must also be accurately placed to ensure that each lead is placed upon the proper pad. Thus, not only must the machine operate extremely fast, but it must also place components extremely accurately.

In order to enhance the quality of board manufacture, fully or partially populated boards are generally inspected after the placement operation(s), both before and after solder reflow, to identify components that are improperly placed or missing or any of a variety of errors that may occur. Automatic systems that perform such operation(s) are highly useful because they help identify component placement problems prior to solder reflow. This allows substantially easier rework and/or the identification of defective boards after reflow that are candidates for rework. One example of such a system is sold under the trade designation Model KS Flex available from CyberOptics Corporation of Golden Valley, Minn. This system can be used to identify such problems as alignment and rotation errors; missing and flipped components; billboards; tombstones; component defects; incorrect polarity; and wrong components.

Identification of errors pre-reflow provides a number of advantages. Rework is easier; closed-loop manufacturing control is facilitated; and less work in-process exists between error generation and remedy. While such systems provide highly useful inspection, they do consume plant floor-space as well as programming time and maintenance efforts.

One relatively recent attempt to provide the benefits of after-placement inspection located within a pick a place machine itself is disclosed in U.S. Pat. No. 6,317,972 to Asai et al. That reference reports a method for mounting electric components where an image of a mounting location is obtained prior to component placement, and compared with an image of the mounting location after component placement to inspect the placement operation at the component level.

While the disclosure of Asai et al. marks one attempt to employ in-machine component level inspection, there remains much work to be done. For example, the disclosure of Asai et al. teaches acquiring two images, before and after the placement of the component to determine placement characteristics of the component. While this approach is useful for determining the absence or presence of a component after placement, there are several important machine characteristics of the placement machine that can cause placement errors of components that this approach does not address.

Significant causes for placement defects in pick and place machine include errors in the setup and programming. Pick and place operations are inherently complicated, depending on many setup parameters and variables to be adjusted properly to ensure all components are placed correctly on the workpiece. Typical circuit boards can contain hundreds or thousands of components, often with hundreds of different component types. The pick and place machine program contains information about the placement location and orientation of all the components, the type of nozzle required to place each of the components, and information about the board size and location. Additionally, the component feeders must be loaded on the pick and place in positions that reflect the anticipated location of the parts by the placement program. Machine parameters, such as placement speed, vacuum amount, nozzle travel, board support placement and calibration parameters must all be set properly to ensure correct placement of all the components.

When required to program the pick and place machine for a new product, the operator will assemble several workpieces and inspect them to determine if the setup parameters and variables are correctly adjusted. This inspection step is typically referred to as “first article inspection.” After adjustment to the pick and place machine, several more workpieces are assembled and inspected to verify that the causes for failures were corrected. Often, it takes several cycles of adjustment and inspection until the pick and place machine reliably places all components on the workpiece. Since the current state of the art for “first article” board inspection requires expensive automatic optical inspection machines or human inspectors, the inspection does not occur until the board is fully assembled and reflowed. The results of this process are a long delay to setup a circuit board production line for a new product and the generation of expensive scrap in the form of inoperable circuit boards. The amount of time required for first article inspection ranges from 5 minutes to 5 hours depending on the complexity of the verification. Typical duration of the first article inspection process is about 30 minutes. These delays increase the complexity of changing a manufacturing line over to a new product, as well as adding cost to the manufactured boards.

In addition to machine setup, problems during machine operation over time can occur due to changes and drift of process parameters. Empty feeders, wrong components placed in the feeders, dry solder paste, and wrong board orientations are a few examples of problems that occur during the operation of the pick and place machine. When such problems occur, it is extremely important that such problems be diagnosed and remedied very quickly to return the line to manufacturing viable boards. When a production line is shut down for diagnostics and repair, expensive technician time is required to remedy the problems. Moreover, as the repair is performed, the technician or an operator may have to run the line through yet another setup cycle in order to verify that the problem is fixed, and that boards can be reliably produced.

### SUMMARY OF THE INVENTION

Embodiments of the present invention provide correlation between positional information relative to the workpiece and inspection information acquired relative to the workpiece. This correlation helps a user or technician quickly identify the physical location, on the workpiece, to which the inspection information pertains. Component inspection information can then be provided to an operator along with an indication of a position of the inspected component on the workpiece.

### BRIEF DESCRIPTION OF THE DRAWINGS

FIG. 1 is a diagrammatic view of a Cartesian pick and place machine with which embodiments of the invention can be practiced.

FIG. 2 is a diagrammatic plan view of a turret pick and place machine with which embodiments of the invention can be practiced.

FIG. 3 is simplified diagrammatic view of an image acquisition system aligned with the placement point of a component placement machine.

FIG. 4 is a diagrammatic view of a pick and place machine with an attached image viewer disposed to display images and data of placement operations.

FIG. 5 is a block diagram of an embedded inspection system providing position correlated inspection information in accordance with an embodiment of the present invention.

FIG. 6 is a block diagram of an embedded inspection system providing position correlated inspection information in accordance with another embodiment of the present invention.

FIG. 7 is a flow diagram of a method of performing embedded component inspection in an electronics assembly machine in accordance with an embodiment of the present invention.

### DETAILED DESCRIPTION OF ILLUSTRATIVE EMBODIMENTS

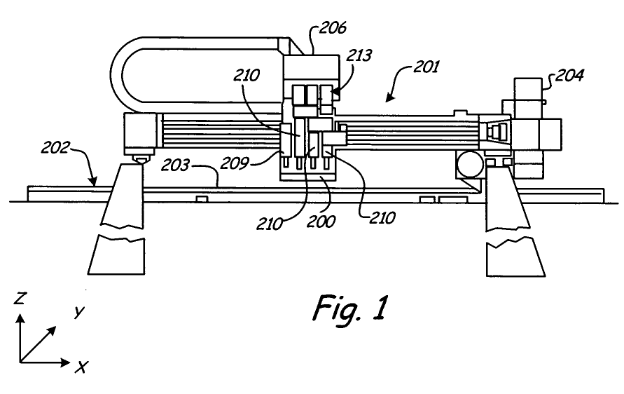

FIG. 1 is a diagrammatic view of an exemplary Cartesian pick and place machine 201 with which embodiments of the present invention are applicable. Pick and place machine 201 receives a workpiece, such as circuit board 203, via transport system or conveyor 202. A placement head 206 then obtains one or more electrical components to be mounted upon workpiece 203 from component feeders (not shown) and undergoes relative motion with respect to the workpiece in x, y and z directions to place the component in the proper orientation at the proper location upon workpiece 203. Placement head 206 may include an alignment sensor 200 that may pass under components held by nozzles 210 as placement head 206 moves the component(s) from pickup locations to placement locations. Sensor 200 allows placement machine 201 to view undersides of components held by nozzles 210 such that component orientation and, to some degree, component inspection can be effected while the component is being moved from the component pick-up location to the placement location. Other pick and place machines may employ a placement head that moves over a stationary camera to image the component. Placement head 206 may also include a downwardly-looking camera 209, which is generally used to locate fiducial marks upon workpiece 203 such that the relative location of placement head 206 with respect to workpiece 203 can be readily calculated.

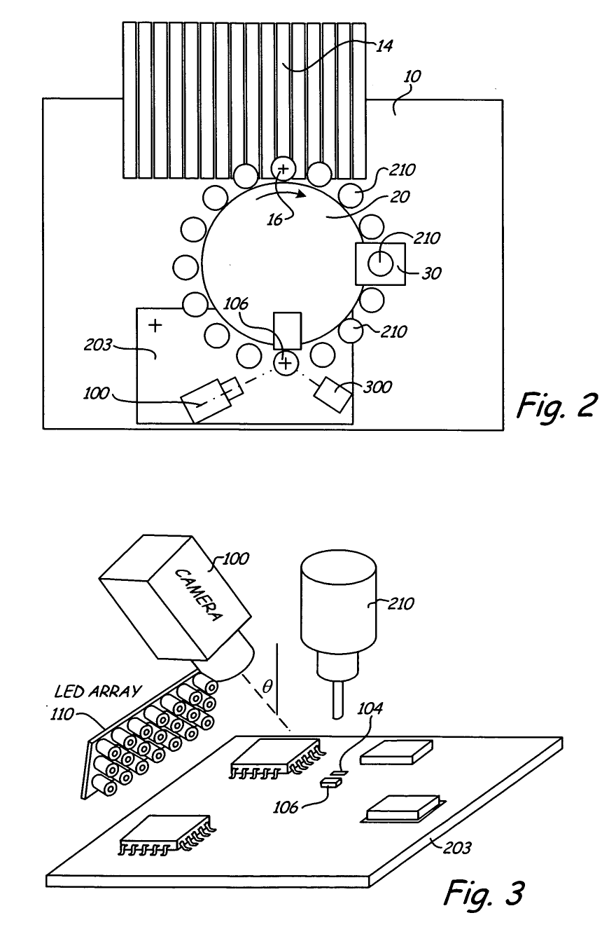

FIG. 2 is a diagrammatic view of an exemplary rotary turret pick and place machine 10 with which embodiments of the present invention are applicable. System 10 includes some components that are similar to machine 201 and like components are numbered similarly. For the turret pick and place machine 10, the workpiece 203 is loaded via a conveyor onto an x-y stage (not shown). Placement nozzles 210 are attached to main turret 20 and are disposed at regular angular intervals around the rotating turret. During each pick and placement cycle, the turret indexes an angular distance equal to the angular distance between adjacent placement nozzles 210. After the turret rotates into position and workpiece 203 is positioned by the x-y stage, a placement nozzle 210 obtains a component 104 from a component feeder 14 at a defined pick point 16. During this same interval, another nozzle 210 places a component 104 onto the workpiece 203 at a preprogrammed placement location 106. Additionally, while turret 20 pauses for the pick and place operation, an upward-looking camera 30 acquires and image of another component 104, which provides alignment information for that component. This alignment information is used by pick and place machine 10 to position workpiece 203 when the corresponding placement nozzle is positioned several steps later to place the component. After the pick and place cycle is complete, turret 20 indexes to the next angular position and workpiece 203 is repositioned in the x-y direction to move the placement location to a position that corresponds to the placement location 106.

During initial setup of the pick and place machine, many parameters and variables must be optimized and set correctly to ensure precise assembly of the workpiece. The following is a list of setup parameters that generally need to be determined:

Types of components;

Types of feeders required to handle the components;

Location of the feeders within the pick and place machine;

Sequence program containing the order and position of component placements;

Nozzle type required for each component;

Size and design of the workpiece;

Position and type of fiducials on the workpiece;

Speed of placement for each type of component;

Vacuum pressure for each type of component;

Vertical stroke of nozzle;

Placement and selection of board support pins;

Orientation of the board;

Vision parameters for component alignment;

Height of the component;

Height of the nozzle during pick and place operations; and

Lighting parameters for component alignment.

During the setup of the pick and place machine, an operator typically follows a procedure to load feeders into proper locations, load nozzles in a cassette, and assemble several workpieces using the appropriate placement program. After the first workpiece or group of workpieces is assembled, the operator inspects each workpiece using visual means or using an automatic optical inspection system. If an error is found, the cause of the error is investigated and corrective action is implemented. After the corrective action is implemented, another group of workpieces is assembled and inspected. This cycle of assembly, inspection and corrective actions is repeated until the operator determines the pick and place machine is ready for production. If first article inspection is performed inside the pick and place machine, the operator is provided with real-time feedback relative to problems occurring during the placement operation. Using this real-time feedback, problems with the setup of the pick and place machine can be diagnosed and corrected quickly before the entire board is completed, thereby reducing scrap.

FIG. 3 is a diagrammatic view of a placement head in accordance with embodiments of the present invention. FIG. 3 illustrates an image acquisition device 100 disposed to acquire images of placement location 106 of component 104 before and after the component 104 is deposited by nozzle 210 upon location 106. Device 100 obtains images of placement location 106 on workpiece 203 prior to placement of component 104 and then shortly thereafter. A comparison of these before and after images facilitates component-level placement inspection and verification. In addition, the area surrounding the component placement location 106 is also imaged. Since acquisition of images of the placement location is generally done when the nozzle, such as nozzle 210, holds the component 104 above the placement location, it is important to be able to image placement location 106 while minimizing or reducing interference from the component itself or adjacent components which may be already mounted upon the workpiece. Thus, it is preferred that the device 100 employ an optical axis allowing views that are inclined at an angle θ with respect to the plane of workpiece 203. An additional advantage of having the device 100 inclined at an angle θ is that vertical motion of the workpiece can be detected and measured by determining the translation of the workpiece between image acquisitions. It is also necessary to precisely time the image acquisition interval such that the workpiece 203 and the placement nozzle 210 are relatively aligned with each other and the component is high enough above workpiece 203 to visualize workpiece 203 from the camera angles. After component 104 is placed, the second image should be timed properly to acquire an image at a pre-selected time during the placement cycle.

Embodiments of the present invention generally obtain two or more successive images of the intended placement location (i.e. before placement and after). Since placement occurs relatively quickly, and since slowing machine throughput is extremely undesirable, it is sometimes necessary to acquire two successive images very quickly since cessation of the relative motion between the placement head and the board is fleeting. For example, it may be necessary to acquire two images within a period of approximately 10 milliseconds.

Rapid acquisition of multiple successive images can be done in different ways. One way is using commercially available CCD devices and operating them in a non-standard manner to acquire images at a rate faster than can be read from the device. Further details regarding this image acquisition technique can be found in U.S. Pat. No. 6,549,647, assigned to the Assignee of the present invention. Yet another way to rapidly acquire multiple successive images is to use multiple CCD arrays arranged to view the intended placement location through common optics.

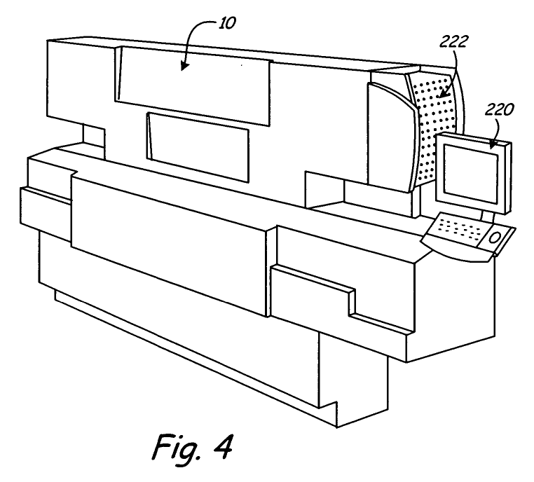

To rapidly diagnose placement problems, it would be advantageous to display errors to the operator(s) during the placement to facilitate correction of the problem before unacceptable amounts of scrap are generated. Also, by sharing placement information with other locations inside and outside the factory, even more expeditious diagnosis and problem resolution are possible. Embedded placement machine inspection systems improve upon component level inspections performed by pick and place machines. Such improvements include providing first article inspection in pick and place machine by collecting images of the placement event inside the machine, processing those images, and identifying errors as they happen. By providing a means to display this information as it is generated on the machine, the operator can take prompt and effective corrective actions. FIG. 4 shows one embodiment of this invention. For this embodiment of the invention, a processor 222 and a monitor 220 are mounted on pick and place machine 10. The location of the monitor 220 is chosen to provide the machine's operator with images and data gathered from the image acquisition system 100 shortly after the placement event. With images and data available to the operator during the assembly of the first board of a production run, the operator is able to make setup changes to the pick and place machine quicker than current practice.

One limitation of recent implementations of retrofit embedded machine inspection systems is that the position of the placement is not known to the inspection system. Therefore, once a misplaced component is identified, it may still be a time-consuming process to determine the actual physical position of the erroneous placement on the workpiece. This problem is significantly amplified in instances where the workpiece is relatively large and has a high density of components. Typical examples include circuit boards for cell phones, computers, et cetera.

Embodiments of the present invention generally focus upon obtaining workpiece positional information (such as x and y coordinate information) when such information cannot be readily obtained from an electronic assembly machine's control system. Embodiments of the present invention can be employed to facilitate expeditious operator intervention with respect to machine setup and/or operation. Placement information that is gathered by the embedded machine inspection system can contain positional information (preferably X and Y coordinates) of the workpiece corresponding to the vision system's collected images. Knowing where the errors are occurring reduces rework time since the operator is able to quickly find the relevant physical location(s) on the workpiece. In some embodiments, the component placement inspection results are correlated with positional information obtained from the control system of the pick and place machine.

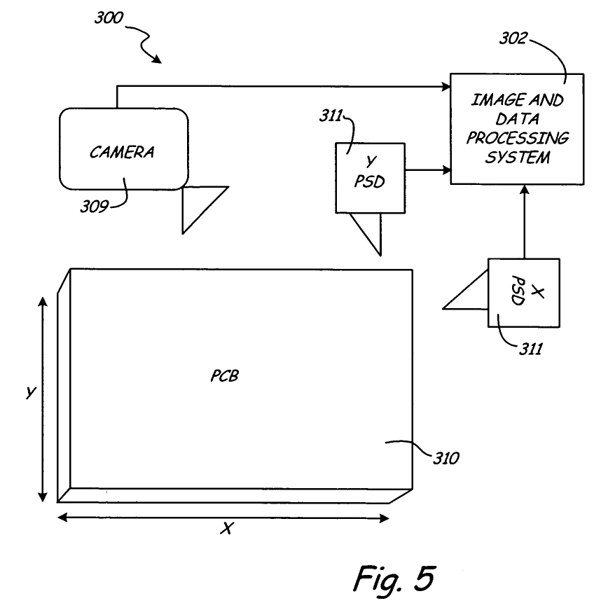

FIG. 5 is a block diagram of an embedded inspection system providing position correlated inspection information in accordance with an embodiment of the present invention. Embedded inspection system 300 includes an image acquisition device, such as camera 309, coupled to image and data processing system 302 such that system 302 receives images from camera 309. As camera 309 collects component placement images occurring on workpiece 310, the X and Y coordinates for each image are sent to system 302 via one or more position sensitive devices 311. Position sensitive devices 311 include any suitable device that is able to provide an electronic indication relative to position. One commercially available position sensitive device is sold under the trade designation Model GP2YDA02YK available from Sharp. Similar devices are also available from Banner Engineering, of Plymouth, Minn.; Omron; and Keyence of Higashi-Nakajima, Japan.

Each of PSDs 311 preferably provides positional information, such as measuring X or Y displacement of the workpiece as the workpiece moves within a pick and place machine. As each component inspection is performed within the pick and place machine, the embedded inspection system 300 records the positional information such that it can be correlated with individual component inspection results. Thus, embedded inspection system can provide individual component inspection results along with the actual position of the component inspected. This can be done by displaying an image of the workpiece to the operator and highlighting, or otherwise annunciating the position of the inspection in the image. Additionally, the highlighting or annunciation can be tailored to be somewhat indicative of overall inspection results. For example, a component that failed inspection may be displayed with a red-tint highlighting it, while a different component that passed inspection may have a green tint over it. In such instances, the operator can select the highlighted region to obtain more specific or complete component inspection information. While FIG. 5 illustrates multiple single axis position sensitive devices, embodiments of the present invention can also be practiced with a single position sensitive device that provides information relative to multiple axes.

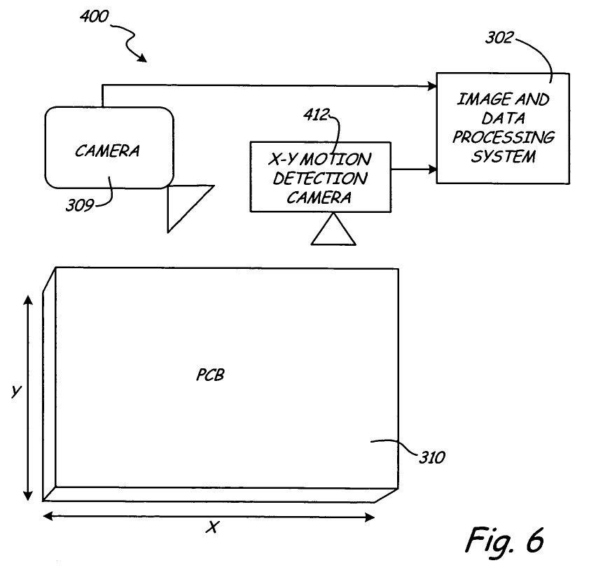

FIG. 6 is a block diagram of an embedded inspection system providing position correlated inspection information in accordance with another embodiment of the present invention. System 400 is similar to system 300 and like components are numbered similarly. Embedded inspection system 400 includes image acquisition device, such as camera 309, coupled to image and data processing system 302. System 302 receives images from device 309. As image acquisition device 309 collects component placement images occurring on workpiece 310, positional information (such as X and Y coordinate information) for each image are sent to image and data processing system from one or more 2-dimensional motion sensitive cameras 412. The technology used for camera(s) 412 can include commercially available and/or publicly known devices that provide indications of motion. Such devices are sometimes used in optical mice. Examples of suitable devices for use as camera 412 include those disclosed in U.S. Pat. Nos. 6,281,882; 5,644,139; and 5,786,804. System 400 acquires X and Y coordinate information from two-dimensional camera 412, which measures the displacement of workpiece 410 as workpiece 310 moves within the electronic assembly machine. As each component inspection is completed, system 400 reads the positional information of the workpiece and stores the positional information as well as data indicative of a relationship between the positional information and the component inspection results. Then, system 400 can report individual component inspection results along with an indication of the physical location on the workpiece where the inspection took place. As set forth above, it is preferred that device 412 employ technology currently found in optical mice. Further, it is preferred that device 412 employ a light-emitting diode, CMOS detector, and a digital signal processor (DSP) that provides data indicative of motion observed by device 412.

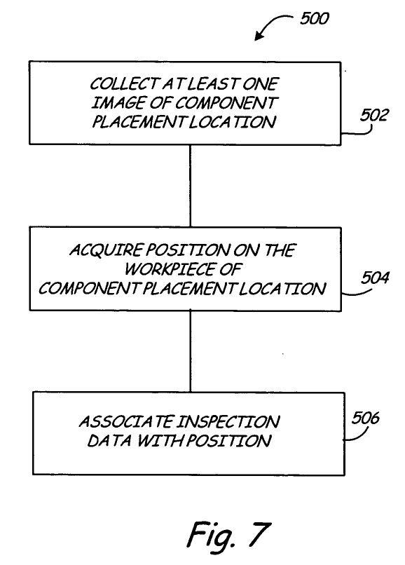

FIG. 7 is a flow diagram of a method of performing embedded component inspection in an electronics assembly machine in accordance with an embodiment of the present invention. Method 500 can be performed to facilitate machine setup as well as machine operation. Essentially, anytime a component is inspected, positional information can be obtained relative to the location of the component on the workpiece. Thus, embodiments of the present invention assist in setting up the electronics assembly machine as well as facilitating quick diagnostics when component inspection(s) indicate a problem. Method 500 begins at block 502 where at least one image of the component placement location is obtained. While the workpiece is located substantially at the same position, positional information relative to the workpiece is obtained, as indicated at block 504. As set forth above, the positional information can be obtained from any suitable position sensitive devices and/or image acquisition devices, such as those in modern optical mice. It is noted that the acquisition of position information can occur at any time when the workpiece is in substantially the same position as when at least one component inspection image is acquired. Accordingly, it is possible in some embodiments for the positional information to be obtained before any image is acquired of the component placement location. Further, such information can be also be acquired after two or more images have been acquired of the component placement location. Further still, positional information can be acquired multiple times during component placement such that average positional information can be computed, which computation may provide better accuracy in environments where the position sensitive devices are susceptible to electromagnetic noise or vibrations.

At block 506, the positional information is associated with the component inspection information. This association can be performed in a vast number of ways. For example, a data structure storing the inspection information may include a pointer, or indication, to a position in an array where the positional information relative to the inspection is stored. Further, the positional information can be superimposed upon an after-placement image of a component that fails inspection.

Although the present invention has been described with reference to preferred embodiments, workers skilled in the art will recognize that changes may be made in form and detail without departing from the spirit and scope of the invention. For example, a positional sensor need not measure the workpiece directly, but may instead measure displacement of any apparatus to which the workpiece is fixed.

What is claimed is:

1. A method of inspecting component placement using an inspection system within an electronics assembly machine, the method comprising:
performing a component placement inspection to obtain component placement inspection information relative to a component on a workpiece at a placement location;
obtaining positional information relative to the placement location; and
associating the component placement inspection information with the positional information.

2. The method of claim 1, wherein the positional information is obtained from at least one position sensitive device.

3. The method of claim 2, wherein the positional information is obtained from a plurality of single axis positional sensitive devices.

4. The method of claim 2, wherein the at least one position sensitive device is a multi-axis position sensitive device.

5. The method of claim 1, wherein the positional information is obtained from a two-dimensional motion sensitive device.

6. The method of claim 5, wherein the two-dimensional motion sensitive device includes a light-emitting diode, a CMOS detector, and a digital signal processor.

7. The method of claim 1, wherein the component placement inspection information and the positional information are displayed to an operator.

8. The method of claim 7, wherein the component placement inspection information is displayed as a particular color at a position corresponding to the positional information.

9. The method of claim 8, wherein a first color is indicative of passing component placement inspection, and a second color is indicative of failing component placement inspection.

10. The method of claim 1, wherein performing component placement inspection includes obtaining at least one image of the placement location prior to component placement, and obtaining at least one image of the placement location after component placement, and contrasting the before and after placement images.

11. A component placement inspection system within an electronics assembly machine, the system comprising:
a camera disposed to acquire a plurality of images of a component placement location on a workpiece;
a position measurement system configured to provide an indication of workpiece position; and
a processing system coupled to the camera and to the position measurement system, the processing system being adapted to associate data relative to the acquired images with the workpiece position.

12. The system of claim 11, wherein the data relative to the acquired images includes component placement inspection information.

13. The system of claim 11, wherein the position measurement system includes at least one position sensitive device.

14. The system of claim 13, wherein the position measurement system includes a plurality of single axis positional sensitive devices.

15. The system of claim 13, wherein the at least one position sensitive device is a multi-axis position sensitive device.

16. The system of claim 11, wherein the positional measurement system includes a two-dimensional motion sensitive device.

17. The system of claim 16, wherein the two-dimensional motion sensitive device includes a light-emitting diode, a CMOS detector, and a digital signal processor.

18. The system of claim 11, and further comprising a display to provide at least one acquired image and the workpiece position relative to the at least one acquired image to an operator.

19. A component placement inspection system within an electronics assembly machine, the system comprising:
means for generating component placement inspection information within the electronics assembly machine;
means for measuring workpiece position;
means for associating data relative to the acquired images with the workpiece position.
